(19) United States
(12) Patent Application Publication
(10) Pub. No.: US 2013/0046840 A1
(43) Pub. Date: Feb. 21, 2013

(54) SYSTEM AND METHOD FOR DYNAMICALLY GENERATING AN EMAIL MESSAGE

(71) Applicants: Sunil Karkera, San Jose, CA (US); Preston Stuteville, Mountain View, CA (US)

(72) Inventors: Sunil Karkera, San Jose, CA (US); Preston Stuteville, Mountain View, CA (US)

(73) Assignee: REGISTRIA, INC., Palo Alto, CA (US)

(21) Appl. No.: 13/587,197

(22) Filed: Aug. 16, 2012

Related U.S. Application Data
(60) Provisional application No. 61/524,117, filed on Aug. 16, 2011.

(51) Int. Cl. G06F 15/16

(52) U.S. Cl. 709/206

(57) ABSTRACT

A method and system to dynamically instantiate and manipulate objects using string and math operations while rendering an email in a web-application server. The method takes directives from the administrator on the objects to instantiate and manipulations to perform using a template language. The administrator can configure manipulation such as finding lengths of strings, sub-strings, addition, subtraction, division, multiplication and modulus operations. The method provides a highly flexible method of determining and rendering the content of the message at run-time.

### PRIORITY

This application claims priority under 35 U.S.C. §119(e) to Provisional Application U.S. Ser. No. 61/524,117 entitled “Information Processing,” filed Aug. 16, 2011, which is incorporated by reference hereto.

Emails are sent by software systems for several purposes such as notification, confirmations etc. When emails are sent addressed to a specific entity regarding a specific subject, the emails are usually personalized. The personalization usually includes the name of the person, address, the type of transaction and transaction details. The data used to generate the email is static and is accessed from a data store. Thus, for some email content, data needs to be recalculated.

During the generation of an email in the server, it would be desirable to have a method to change the content of the email dynamically. For example, the ability to perform mathematical or string operation within the email and generate the email with those calculated values would be helpful.

The embodiments of the invention allow for the calculation of values in real-time while generating the email by having functions, methods and objects within the email template as tags and filters. Tags are strings derived from static data present in the database. For example, accessing a value that is already saved in the database:

{{User.age}}

{{User.gender}}

{{Product.name}}

Filters are functions to which one or more parameters are passed. The resultant value will be derived based on one or more functions that use the passed parameters. Example of filters are: {{registration.purchase_date|date_greater_than: ‘2012-07-05’}}

Because the embodiments of the invention utilize object oriented programming, there is object oriented access to data in real-time. For example, in the example described below, “user.registrations.first.product.name” is such an example. This will pull the information about the particular user's first product name that can then be put in the body of the email message.

The embodiments of the invention provide several advantages over traditional methods of generating email messages. In particular, there is a reduction of data access from backend databases. Since the operations and calculations are performed at runtime during email generation, there is a reduced need to access backend data store. In addition, since email content can be generated dynamically during runtime, there is a reduced need to create different types of email templates. This reduces cost in design and management of changes. Also, some content in emails are sometimes not available in backend data stores. The embodiments of the invention allow derivation of calculated dynamic data during runtime.

### BRIEF DESCRIPTION OF THE FIGURES

FIG. 1 illustrates a multi-tenant hosted web application system on which the embodiments of the invention are implemented.

FIG. 2 illustrates conceptually an example of an email template that contains examples of styling and the code that generates email content once it is processed by the email processor.

FIG. 3 shows object instantiated during the processing of the email based on the tags used on the email template.

FIG. 4 illustrates an example function that can be invoked to return dynamic data to the email during processing of the email.

FIG. 5 is a flow chart illustrating a process of creating and sending an email message e with dynamic content.

FIG. 6 illustrates an implementation of the source code to process the email with its dynamic elements.

### DETAILED DESCRIPTION

Software as a service (SaaS), sometimes referred to as “on-demand software”, is a software delivery model in which software and associated data are centrally hosted on the cloud. SaaS is typically accessed by users using a thin client via a web browser.

SaaS has become a common delivery model for many business applications, including accounting, collaboration, customer relationship management (CRM), management information systems (MIS), enterprise resource planning (ERP), invoicing, human resource management (HRM), content management (CM) and service desk management. SaaS has been incorporated into the strategy of all leading enterprise software companies. One of the biggest selling points for these companies is the potential to reduce IT support costs by outsourcing hardware and software maintenance and support to the SaaS provider.

The vast majority of SaaS solutions are based on a multi-tenant architecture. With this model, a single version of the application, with a single configuration (hardware, network, operating system), is used for all customers (“tenants”). To support scalability, the application is installed on multiple machines (called horizontal scaling). This is contrasted with traditional software, where multiple physical copies of the software—each potentially of a different version, with a potentially different configuration, and oftentimes customized—are installed across various customer sites.

SaaS applications similarly support what is traditionally known as application customization. In other words, like traditional enterprise software, a single customer can alter the set of configuration options (a.k.a., parameters) that affect its functionality and look-and-feel. Each customer may have its own settings (or: parameter values) for the configuration options. The application can be customized to the degree it was designed for based on a set of predefined configuration options.

SaaS applications are often updated more frequently than traditional software, in many cases on a weekly or monthly basis. This is enabled by several factors:
The application is hosted centrally, so new releases can be put in place without requiring customers to install new software.
The application only has a single configuration, making development testing faster.
The application vendor has access to all customer data, expediting design and regression testing.

Several important changes to the software market and technology landscape have facilitated acceptance and growth of SaaS solutions, among which include:
The standardization of the web stack (HTML, JavaScript, CSS, HTTP), the increasing popularity of web development as a practice, and the introduction and ubiquitousness of web application frameworks like Ruby on Rails gradually reduced the cost of developing new SaaS solutions, and enabled new solution providers to come up with competitive solutions, challenging traditional vendors.
The increasing penetration of broadband Internet access enabled remote centrally-hosted applications to offer speed comparable to on-premises software.

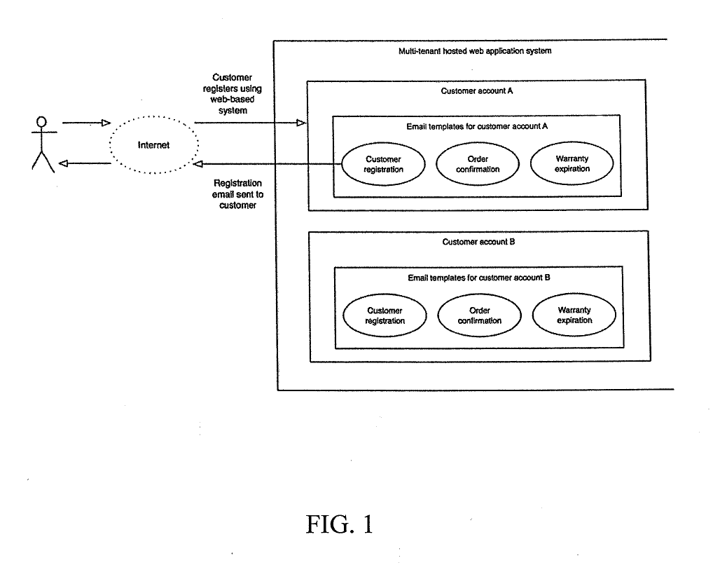

FIG. 1 illustrates a multi-tenant hosted web application system on which the embodiments of the invention are implemented. In particular, the embodiments of the invention revolve around registration by customers of products that have warranties associated therewith and the management of such information. Of course, other types of information are subject to the embodiments of the invention.

Software applications oftentimes need to send email communications to users and customers for various transactions such as user registration, product registration, order confirmation, shipment confirmation, etc. Emails are either plain text or contain HTML markup. Emails are sent to the available customer email address using email servers via standard Internet communications protocols.

Current software applications generate static emails with very little configurable content. Configurable content ranges from dynamically replacing information like customer name or product names. It is often required that at the time of generating the email, new information is created or updated. This requires emails to have conditional logic as well as string and math function to derive this. As an example, if a customer registered a product with a warranty associated therewith, the system would scan certain parameters and if an event was detected such as, a need to send an email to the customer that the warranty is expiring in a certain amount of time an email would be sent to the user. The system could also send reminders where each reminder has the number of days left on the warranty, for example, calculated during the generation of the email. Also, the appearance of the reminders can change dynamically based on the calculation of the remaining life on the warranty to grab the customer's attention, so the reminders may become red, for example, as the time on the warranty decreases. Of course, those of ordinary skill in the art will appreciate that the particular type of data dynamically generated will depend on the purpose the embodiments of the invention are used and the embodiments of the invention are not limited to those described herein.

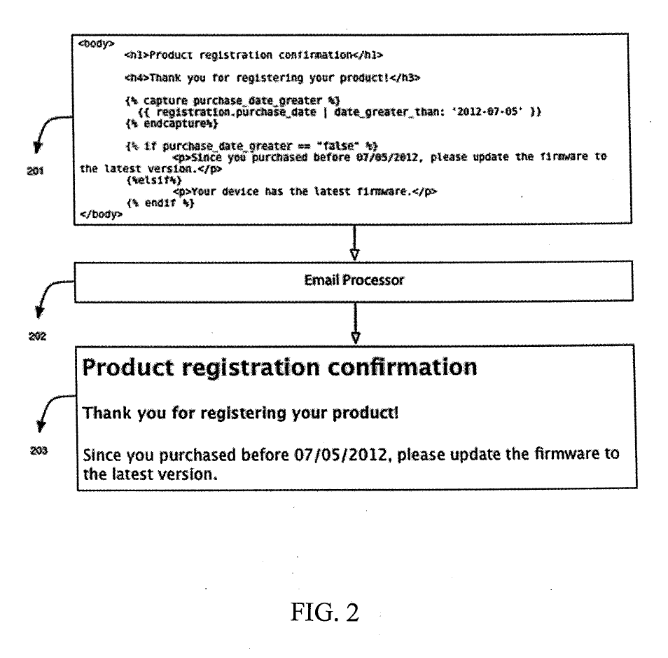

FIG. 2 illustrates conceptually an example of an email template that contains examples of styling and the code that dynamically generates email content once it is processed by the email processor. The email template 201 in this example has code that, when processed by the email processor 202, will generate the email message 203. The processor has the ability to perform date calculations such as date greater than today, number of days from today, etc. and output results of type true or false. The true or false data can be used by conditional logic to generate and output different elements in the email as programmed in the email template. This provides a high degree of control of the email generation without proliferating versions and variations of email templates or logic outside the email template itself. In this particular example, conditional logic is used in the code of the email template 201 to compare a product purchase date against a date provided as a parameter and generates a true if the purchase date is greater than the parameter date, in this case Jul. 5, 2012, or a false if it is not. Based on the result of this comparison, the email generated by the processor can have different content, one if the comparison proved true and another if the comparison proved false. In this particular example, because the comparison generated a false, the content in the email was “Since you purchased before Jul. 5, 2012, please update the firmware to the latest version.” If the comparison had generated a true, then the content in the email message would have been different and instead of saying the firmware needed to be updated, it would have said “Your device has the latest firmware.”

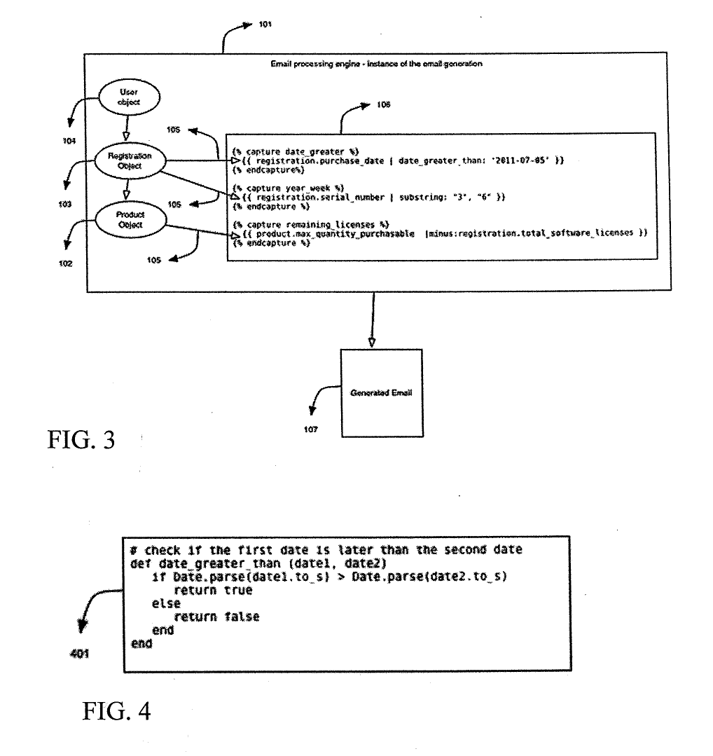

FIG. 3 shows object instantiated during the processing of a portion of the email based on the tags used in the email template. The ellipses for User 104, Registration 103, and Product 102 are examples of objects instantiated while processing the email. The instantiation of these objects are based on their usage in the code within the email template. Using these objects, data for their instances can be access as per the following example:

registration.user.first_name: allows access to the first name of the user who registered the product

regisrtation.product.name: allow access of the name of the registered product

registration.entitlements.first.expiry_date: allows access to the expiry date of the first entitlement associated with the registration.

In the example shown in FIG. 3, two registration objects and one product object as shown and data can be respectively accessed for their instances by:

registration.purchase_date: allows access to the date of purchase of the product

registration.serial.number: allows access to the serial number of the product purchased

product.max_quantity_purchasable: allows access to the number of products purchased

The example shown in FIG. 3 also shows how to chain multiple objects and access their related objects and properties.

FIG. 4 illustrates an example function that can be invoked to return dynamic data to the email during processing of the email. In this particular example illustrated, the function or method is to compare dates. This function or method can be used in the email template to compare dates in real-time and generate different content based on a true or false result.

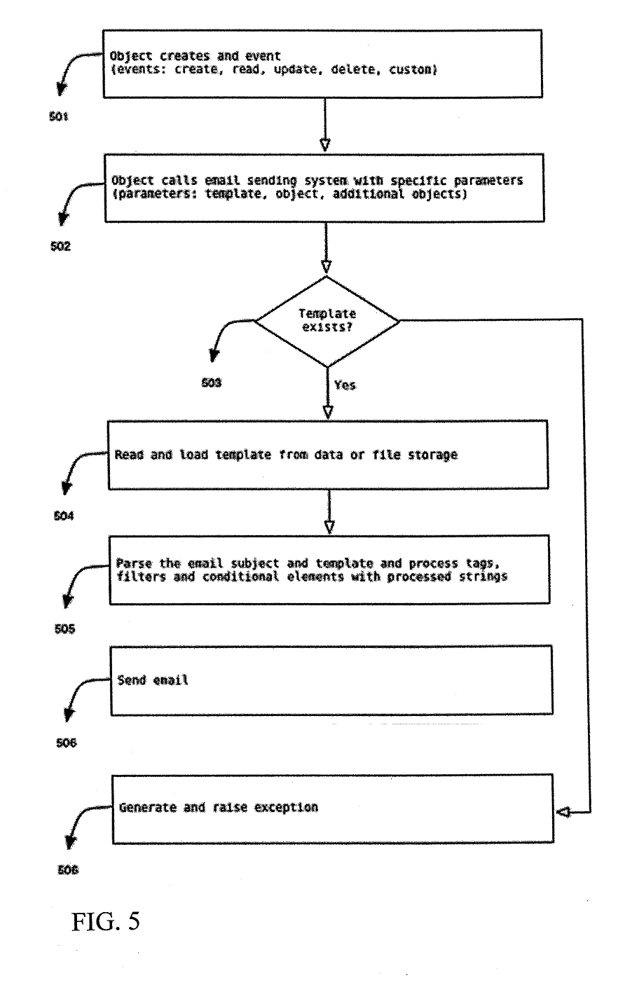

FIG. 5 is a flow chart illustrating a process of creating and sending an email message with dynamic content. At step 501 an object creates an event. Examples of events could be create, read, update, delete and custom, for example. For example, suppose a user purchased a product that had a warranty period of a certain period. When the user purchased that product, they entered into computer database information about themselves, the product, when they purchased the product, for example. Suppose the warranty period was close to expiring. The database is periodically checked for registered products that are close to expiring. An event is created upon that occurrence. At step 502, the object calls an email sending system with specific parameters. The parameters would include template information, in this example, one tailored to notifying the user that the warranty is expiring. Additional parameters could include template information, in this example, one tailored to notifying the user that the warranty is expiring. Additional parameters could include:

{{registration.product.name}}

{{registration.product.available_warranties}}

{{registration.warranty_expiry_date}}

{{registration.user.first name}}

At step 503 it is determined whether there exists an appropriate template for the event. If not, then at step 506 an exception is generated and raised. Upon the occurrence of an exception, preferably, an email is not sent to the user but rather a record of the exception is logged in the database for access by an administrator.

If it was determined at step 503 that a template exists, then at step 504 the template is read and loaded into the email processor from a data storage or file storage, for example.

At step 505, dynamic parsing and processing of the email occurs to create an email message with dynamic content and at step 506 the email is sent to at least one user.

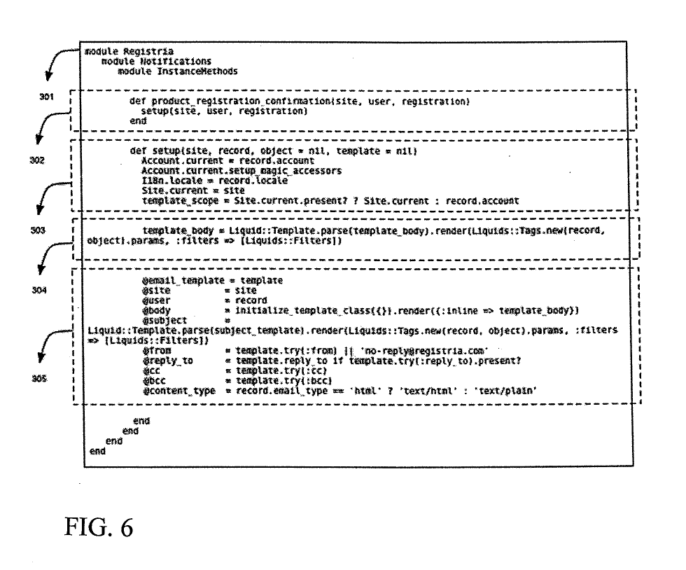

FIG. 6 illustrates an implementation of the source code to process the email with its dynamic elements by the email processor. In this preferred embodiment, the programming language is Ruby 1.8, however, any object oriented programming language may be used to carry out any of the embodiments of the invention. In this example, block 301 represents a standard Ruby programming language module that is name-spaced to the name of the sending system. So all calls to send the email should include this name first. In this example implementation, a caller will have to instantiate any methods within this module using: Registria:Notifications. Block 302 represents a method within the module that if one of several methods that are instantiated by the events that need to send an email. The method accepts parameters that help it construct the email sending method. Block 303 represents a method that composes the email that needs to be sent. The composition first deriving the language the email should be sent based on the locale of the object (for instance, user object); the current customer account and the template to be used. Block 304 represents the body of the email is constructed by parsing the tags and filters in the template and replacing them with dynamically derived data and strings. Block 305 represents the header of the email is composed by setting the subject of the email, one or more email addresses to be sent to, cc'd to and or bcc'd to. Then the content type of the email is set—html or plain text.

Thus, when an event occurs that requires the system to send an email to a user or customer, a function or method invokes a specific method 302, 502 with the parameters and objects required for processing that instance of the email.

For example, if a user registered a product, the system invokes the method 301 to send an email for confirming the registration of the product. The objects and parameters passed to this method can be the instance of the product registration, the instance of the registered product and the user object that registered the product.

The method 301 in turn invokes the method that contains the logic to query and fetch the email template 303 required to process and send the email, query, fetch and generate the message envelope 304 (from address, send-to address, reply-to address, email subject) and parse and process dynamic content found in the email template.

The dynamic content from the email template is parsed from the email template and passed to a processor 304 which contains several methods for adding instance data, methods for processing date logic as well as string manipulation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semi-conductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., a document creation component) or related data available in the cloud. For example, the document creation component could execute on a computing system in the cloud and allow users to create templates for use in generating content using a graphical interface. In such a case, a document creation component could receive a user-created template, generate new content based on the template, and store the generated content at a storage location in the cloud. Doing so allows users to access the generated new content from any computing system attached to a network connected to the cloud (e.g., the Internet).

What is claimed is:

1. A computer-implemented method for generating an email message with dynamic content comprising:
retrieving an email template from a repository in response to an event, the email template having functions, methods and objects within the email template as tags and filters to create both static and dynamic wherein the dynamic content is configurable dependent upon the event that generated the retrieval;
Processing the email template to generate the dynamic content in the email template; and
generating an email from the processed email template.

2. A method according to claim 1 wherein the methods include conditional logic, tags and filters.

3. A method according to claim 1 wherein the methods include string functions.

4. A method according to claim 1 wherein the methods include math function.

5. A method according to claim 1 wherein the processing the email template includes receiving parameterized instructions and objects for a processor to query and construct required objects and strings.

6. A method according to claim 2 wherein the processing the email template includes parsing and processing conditional logic and tags embedded in the email template.

7. The method of claim 1 further comprising depositing in a repository a plurality of different templates wherein at least two templates have dynamic content

8. A method for generating an email message with dynamic content comprising:
creating an event;
activating an email sending system based on the event to retrieve an email template based on the event, the email template having dynamic content;
processing the email template to create dynamic content to create an outbound email message unique to the event; and
sending the outbound email message to at least one recipient.

9. A system adapted to create an email message with dynamic content comprising:
a processor
a memory operatively couple to the processor containing a program that, when executed by the computer processor, performs operations for creating dynamic content in an email message, comprising
activating an email sending system based on a received event to retrieve an email template based on the event, the email template having dynamic content;
processing the email template to create dynamic content to create an outbound email message unique to the event; and
sending the outbound email message to at least one recipient.

10. A computer program product for creating dynamic content in an email message comprising:
a computer-readable storage medium having computer readable program code comprising:
computer readable program code to activate an email sending system based on the event to retrieve an email template based on the event, the email template having dynamic content;
computer readable code to process the email template to create dynamic content to create an outbound email message unique to the event; and
computer readable code to send the outbound email message to at least one recipient.
